(19) United States
(12) Patent Application Publication
(10) Pub. No.: US 2026/0361331 A1
(43) Pub. Date: Nov. 12, 2026

(54) WIRELESS NETWORK ACCESS POINTS WITH DISPLAY FUNCTIONALITY

(71) Applicant: Fortinet, Inc., Sunnyvale, CA (US)

(72) Inventors: Sekhar Sumanth Gorajala Chandra, Sunnyvale, CA (US); Reuben Stanley Wilson, Shrewsbury (GB)

(73) Assignee: Fortinet, Inc., Sunnyvale, CA (US)

(21) Appl. No.: 19/201,600

(22) Filed: May 7, 2025

(51) Int. Cl. H04B 1/40; H04B 1/03; H04W 88/08

(52) U.S. Cl. CPC H04B 1/40; H04B 1/03; H04W 88/08

(57) ABSTRACT

Wireless network access points (APs) having display devices are described. The AP includes a rear enclosure section and a front enclosure section configured to mate with the rear enclosure section provide a housing to enclose electronic components that provide access point functionality to the AP. The front enclosure provides visual access to a display device disposed within the housing. A main circuit board having processors, memory devices and a wired network interface is housed in the AP. A display device controller coupled with the main circuit board and with the display device provides graphics processing functionality. A display device and antenna holder securely positions the display device and antennae within the housing when the rear enclosure section and the front enclosure section are securely attached together to minimize interference between the display device and the one or more antennae.

### BACKGROUND

A wireless access point (AP) is a network device that allows wireless-capable devices (e.g., laptops, smartphones, Internet of Things (IoT) gadgets) to connect to a wired network using Wi-Fi (e.g., IEEE 802.11) standard protocols. APs transmit and receive data over radio frequencies (e.g., 2.4 GHz bands, 5 GHz bands) and connect to wired (e.g., Ethernet) networks. Thus, APs act as a bridge between wired and wireless networks. APs can also enforce security protocols (e.g., WPA2). The internal electronics of APs are generally enclosed in a plastic enclosure that can be, but often is not, moisture-proof or weather-proof.

### TERMS AND DEFINITIONS

Brief definitions of terms used throughout this application are given below.

The term “client” generally refers to an application, program, process, or device in a client/server relationship that requests information or services from another program, process, or device (a server) on a network. Importantly, “client” and “server” are relative since an application may be a client to one application but a server to another. The term “client” also encompasses software that makes the connection between a requesting application, program, process, or device to a server possible, such as a file transfer protocol (FTP) client.

The phrase “endpoint protection platform” generally refers to cybersecurity monitoring and/or protection functionality performed on behalf of an endpoint (or client) device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and leverage code-tracing technology to detect advanced threats such as in-memory malware. The endpoint protection platform may provide monitoring and/or protection functionality on behalf of the endpoint device via an agent, which may be referred to herein as an “endpoint security agent” deployed on the endpoint device. Non-limiting examples of an endpoint protection platform include the FORTIEDR Software as a Service (SaaS) platform and the FORTICLIENT integrated endpoint protection platform available from Fortinet, Inc. of Sunnyvale, CA. In some examples, the endpoint protection platform is a participant in a cybersecurity mesh architecture (CSMA) in which various cybersecurity products/solutions/tools of a given cybersecurity or networking security vendor or across a group of participating vendors achieve a more integrated security policy by facilitating interoperability and communication among the various cybersecurity products/solutions/tools (e.g., network security appliances, a secure access service edge (SASE) platform, etc.).

The phrase “endpoint security agent” generally refers to endpoint software that runs on an endpoint device (e.g., a desktop computer, a laptop computer, or a mobile device) and monitors for cybersecurity issues arising on the endpoint device and/or protects the endpoint device against cybersecurity issues. In some examples, the endpoint security agent may be deployed on the endpoint device as a fabric agent that delivers protection, compliance, and secure access in a single, modular, lightweight client. A fabric agent may be endpoint software that runs on an endpoint device and communicates with a telemetry connection or a cybersecurity mesh (e.g., the Fortinet Security Fabric available from Fortinet, Inc. of Sunnyvale, CA) to provide information, visibility, and control to that device. In some examples, the endpoint security agent may be in the form of a lightweight endpoint agent that utilizes less than one percent of CPU and less than 100 MB of RAM and may leverage, among other things, various security event classification sources provided within one or more associated cloud-based security services.

A non-limiting example of an endpoint security agent is the FORTICLIENT Fabric Agent available from Fortinet, Inc. of Sunnyvale, CA. In one example, to simplify the initial deployment and offload ongoing monitoring, an endpoint security agent may be managed and/or supported by one or more endpoint-focused managed services, for example, to provide setup, deployment, configuration, vulnerability monitoring, and overall endpoint security monitoring. In the context of a CSMA, the endpoint security agent may communicate with an endpoint protection platform, one or more network security appliances, and/or one or more cloud-based security services via a telemetry connection and/or via application programming interface (API) integration. In some examples, the endpoint security agent enables remote workers to connect to the network using zero-trust principles securely and may enable both Universal ZTNA and Virtual Private Network (VPN)-encrypted tunnels, as well as URL filtering and cloud access security broker (CASB). The endpoint security agent may additionally provide enhanced security capabilities through artificial intelligence (AI)-based NGAV, endpoint quarantine, and application firewall, as well as support for cloud sandbox, USB device control, and ransomware protection.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software to perform one or more security functions. Other network security devices may include custom hardware (e.g., one or more custom Application-Specific Integrated Circuits (ASICs)).

For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, and NPs. Mid-range network security devices may include one or more multi-core CPUs, one or more separate NP Application-Specific Integrated Circuits (ASICs), and one or more CP ASICs. At the high end, network security devices may have multiple NPs and/or multiple CPs. A network security device is typically associated with a particular network (e.g., a private enterprise network) on behalf of which it provides one or more security functions.

Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations as a unified threat management (UTM) solution.

Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

As used herein, “Zero-Trust Network Access” or “ZTNA” generally refers to a set of technologies and functionalities that enable secure access to internal applications for local or remote users (e.g., utilizing on-net endpoint or client devices within an enterprise network or off-net endpoint or client devices outside of the enterprise network, respectively). ZTNA represents the evolution of VPN remote access, bringing the zero-trust model to application access. ZTNA may be used to authenticate and authorize access to resources based on identity, device, and/or contextual data. ZTNA solutions typically grant access on a per-session basis to individual applications only after devices and users are verified.

As used herein, a “ZTNA Access Point” or “ZTNA AP” generally refers to any hardware device, software application, or combination of hardware and software that may be used to control access to protected network devices, servers, resources, services, TCP applications, and/or databases by a requesting endpoint device. In some cases, a ZTNA AP runs one or more access proxies, including a TFAP. Depending on the particular implementation, a ZTNA may be provided in virtual or physical form. For example, a ZTNA AP may be a virtual node or container that runs one or more access proxies or a network security appliance (e.g., a UTM appliance) that runs one or more access proxies.

As used herein, a “secure connection” generally refers to a connection provided through a computer network by one or more protocols that secure communication and data transfers via the connection, for example, via end-to-end encryption. Non-limiting examples by which a secure connection may be established include HTTPS, Hypertext Transport Protocol version 1.1 (HTTP 1.1) over SSL, Hypertext Transfer Protocol version 2.0 (HTTP 2.0) over SSL, Hypertext Transfer Protocol version 3.0 (HTTP 3.0) over Quick User Datagram Protocol (UDP) Internet Connections (QUIC).

A “computer” or “computer system” may be one or more physical computers, virtual computers, or computing devices. As an example, a computer may be one or more server computers, cloud-based computers, cloud-based clusters of computers, virtual machine instances, or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers unless expressly stated otherwise.

The terms “connected” or “coupled” and related terms are used in an operational sense and are not necessarily limited to a direct connection or coupling. Thus, for example, two devices may be coupled directly or via one or more intermediary media or devices. As another example, devices may be coupled so that information can be passed between them without sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” “in an example,” “in some examples,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an architecture that can one or more access points (APs) having a display device.

FIG. 2 is an external view of an example wireless network access point (AP) having an integrated display device.

FIG. 3 is an exploded view of an example wireless network access point (AP) having an integrated display device.

FIG. 4 illustrates an example enclosure top and back where the enclosure top allows for a display device.

FIG. 5 is an example illustration of an AP indicating relationships between various components of the AP.

FIG. 6 is an example partial side-view illustration of an AP indicating relationships between various components of the AP with the AP fully assembled.

FIG. 7 is an example of a system to perform an example initialization phase corresponding to an architecture that can provide endpoint client authentication and application access control in a zero-trust network access (ZTNA) environment.

FIG. 8 is a block diagram that illustrates an example access point (AP).

### SUMMARY

In an example, wireless network access point (AP) comprises a rear enclosure section and a front enclosure section configured to mate with the rear enclosure section provide a housing to enclose electronic components that provide access point functionality to the AP. The front enclosure has at least a lens (or a opening) to provide visual access to a display device disposed within the housing. The housing further encloses a main circuit board with one or more processors, one or more memory devices and a wired network interface, a display device controller coupled with the main circuit board and with the display device, the display device controller to provide graphics processing functionality with respect to content displayed by the display device, and a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae.

In an example, the display device is a liquid crystal display (LCD) device and the display device controller is and LCD controller. In an example, the display device is a light emitting diode (LED) device and the display device controller is and LED controller.

In an example, the display device is caused to display a static image. In an example, the display device is caused to display a dynamic image. In an example, the dynamic content includes statistical information related to operational parameters of the wireless network. In an example, the dynamic content comprises customized information related to a device attempting to join the wireless network.

In an example, wireless network includes multiple access points (APs) interconnected to provide access to a wired network to a plurality of wireless devices. A first AP of the multiple APs comprises a rear enclosure section and a front enclosure section configured to mate with the rear enclosure section provide a housing to enclose electronic components that provide access point functionality to the AP. The front enclosure having at least a lens (or opening) to provide visual access to a display device disposed within the housing. The housing further encloses a main circuit board having one or more processors, one or more memory devices and a wired network interface, a display device controller coupled with the main circuit board and with the display device, the display device controller to provide graphics processing functionality with respect to content displayed by the display device, and a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae.

In an example, a wireless network access point (AP) includes a rear enclosure section, and a front enclosure section configured to mate with the rear enclosure section provide a housing to enclose electronic components that provide access point functionality to the AP. The front enclosure providing visual access to a display device disposed within the housing. The housing further encloses a main circuit board having one or more processors, one or more memory devices and a wired network interface, a display device controller coupled with the main circuit board and with the display device, the display device controller to provide graphics processing functionality with respect to content displayed by the display device, and a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae. The one or more processors of the main circuit board execute instructions stored by the one or more memory devices of the main circuit board, the instructions, when executed, cause the display device controller to cause the display device to display content as indicated by the instructions.

### DETAILED DESCRIPTION

As mentioned above, wireless access points (APs) are typically enclosed in a plastic housing (e.g., a front enclosure mated to a rear enclosure) that protects the internal electronic components from some level of shock and/or contamination. The enclosure can include vents for thermal management attachment points for mounting. In order to not interfere with network communications, the enclosure is generally made of materials that allow radio signals of the supported frequency ranges to pass through. Thus, ABS plastic is a common material; however, other materials can also be used for the AP housing

The functionality of the enclosure material is generally limited to the purposes and functions described above. That is, the AP enclosure provides no (or very little) hardware or software related functionality other than access between wireless devices and a wired network. Further, the AP enclosure provides little to no aesthetic purpose (e.g., plain white plastic, plain black plastic). As described in greater detail below, an AP enclosure can be adapted to provide additional functionality and/or aesthetic appeal, which increases the functionality and/or the aesthetic appeal of the AP.

Various functional improvements to APs (and similar wireless devices) are described below. The illustrated examples are intended to be examples and not a restrictive listing of possibilities. The improvements can be related to hardware functionality, software functionality, aesthetic improvements or any combination thereof. In various examples, a display device (e.g., light-emitting diode (LED)-based, liquid crystal display (LCD)-based) can be integrated into an outer enclosure of an AP that can be powered by, and connected to, the AP circuitry using various connector types (e.g., Elastometric, heatseal, Flexible Bus Connector (FBC)/Flexible Flat Cable (FFC), Universal Serial Bus (USB) port).

In an example, a top cover of the AP can include an integrated display (or a lens or an opening for the display) that can be programmed and controlled via software running on the AP (or other device) and/or a display controller to provide information and/or additional functionality related to hardware of the AP. In the examples that follow, antenna designs have been modified based on, for example, placement of the display device to limit obstruction of Wi-Fi signals.

In an example, with respect to a traditional AP design, the top cover is redesigned to accommodate the display device and an LCD controller module (or other type of controller). Further, one or more antennae parameters are modified to accommodate the inclusion of the display device and the LCD controller. One or more additional connectors have been added to the main board to provide control and/or management of the LCD via the LCD controller. Additional connectors and/or use of different transmit/receive parameters may also be utilized to compensate for the new antenna design.

Various examples can also provide improved information and/or improved software functionality. In an example, a Quick Response (QR) code can be displayed to assist with, for example, network guest login procedures. In other examples, advertisements can be presented and/or critical information (e.g., emergency alerts, building maps) can be provided. Greetings and/or customer/patient names can be shown upon entering a premises to assist with service registration and/or network access.

In other examples, the display device can provide information related to the network functionality of the AP. For example, a pie chart of bandwidth utilization by application can be displayed. In other examples, initiation and/or setup information can be provided.

In other examples, warning or problem status information (e.g., high bandwidth utilization, pool or queue reaching a threshold) can be provided.

In an example, the display can be a screen saver or can match the background to which the AP is attached to make the AP more aesthetically pleasing. A real-time video feed (e.g., a nature scene, security video) from a remote source can be displayed.

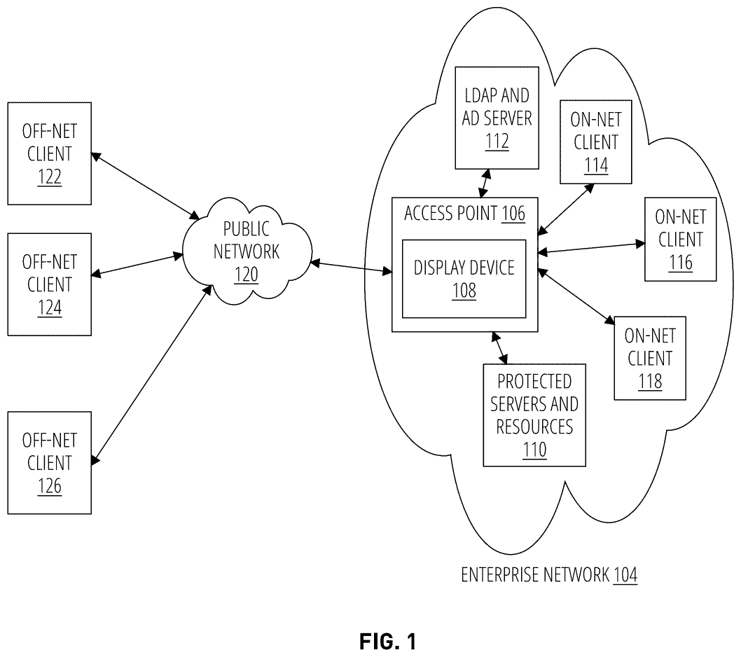

FIG. 1 is a block diagram of an architecture that can one or more access points (APs) having a display device. In the context of the present example, multiple off-net clients (e.g., off-net client 122, off-net client 124, off-net client 126) access enterprise network 104 via public network 120 (e.g., the Internet). The off-net clients may represent endpoint or client devices (e.g., workstations, desktop computers, laptop computers, or mobile devices) used by remote workers associated with a particular organization or enterprise.

In an example, enterprise network 104 includes Lightweight Directory Access Protocol (LDAP) and Active Directory (AD) (LDAP and AD) server 112, access point 106, protected servers and resources 110, and multiple on-net clients (e.g., on-net client 114, on-net client 116, on-net client 118). In an example, the on-net clients are locally attached client devices used by onsite workers. In an example, access point 106 is a network security appliance operable within enterprise network 104. Access point 106 may be responsible for controlling access to protected servers and resources 110, which may include various protected network devices, servers, resources, services, TCP applications, and/or databases. For example, as is known in the art, access point 106 may evaluate policies to determine what devices and users can access a given target service of protected servers and resources 110. In an example, access point 106 includes display device 108 that can be integrated into an enclosure of access point 106 to provide various information and/or images as described herein.

In an example, when a given user session matches a policy, access point 106 may set up a proxy tunnel session (e.g., a TFAP tunnel) between an endpoint security agent (not shown), running on a requesting endpoint device (e.g., one of the off-net clients or one of the on-net clients) and acting as a proxy on behalf of a client application (e.g., a browser), and the target service. In some cases, the evaluation of the policies may include consulting LDAP and AD server 112regarding a user's AD group and/or domain. For example, access to one or more of protected servers and resources 110 may be limited to a requesting endpoint that belongs to AD. In some examples, access to certain Virtual Local Area Networks (VLANs) may be based on the logged in user's AD group membership. Deny policies can be used with endpoints when they fall outside of security posture policies; for example, access may be denied to certain resources or network segments if an endpoint is tagged with critical vulnerabilities.

One or more components illustrated in FIG. 1 can utilize Zero-Trust Network Access (ZTNA) technologies and functionalities that enable secure access to internal applications for local or remote users (e.g., utilizing on-net endpoint or client devices within an enterprise network or off-net endpoint or client devices outside of the enterprise network, respectively). ZTNA may be used to authenticate and authorize access to resources based on identity, device, and/or contextual data. ZTNA solutions typically grant access on a per-session basis to individual applications only after devices and users are verified.

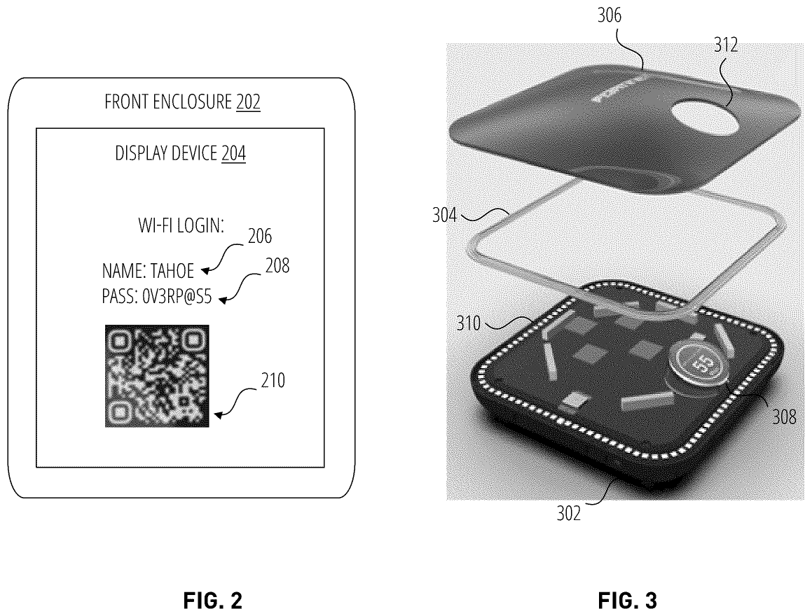

FIG. 2 is an external view of an example wireless network access point (AP) having an integrated display device. The example of FIG. 2 illustrates a wireless AP with an integrated display device that provides Wi-Fi login information.

More specifically, the AP of FIG. 2 includes front enclosure 202 that encloses the electronic components of the AP (not illustrated) and has embedded (or integrated or enclosed) within it display device 204. In the example of FIG. 2, display device 204 is configured to display Wi-Fi login information (e.g., network name 206 and password 208, QR code 210). As mentioned above, displaying Wi-Fi login information is one of the many types of information that may be displayed via display device 204.

The example configuration illustrated in FIG. 2 can simplify the process of accessing a network. This may be useful in a commercial or medical setting where visitors (e.g., customers, patents, vendors) may want to access the local network, which can disrupt employees of the local office with questions related to network access.

FIG. 3 is an exploded view of an example wireless network access point (AP) having an integrated display device. The example of FIG. 3 illustrates a wireless AP with an integrated display device that provides status information. The example of FIG. 3 provides an opening (rather than, for example, a lens as illustrated below) in the upper enclosure to allow visual access to the display device.

The example AP of FIG. 3 includes enclosure 302 that houses electronic components of the AP. In an example, LED lights 310 can be controlled to provide ambient lighting and/or provide status information related to, for example, the AP. In an example, LED lights 310 can provide status information for the AP (e.g., white or green indicating normal operation, yellow or flashing white indicating a warning condition, red indicating a failure). In an example, trim piece 304 provides an interface between LED lights 310 and top cover 306.

In an example, display device 308 can provide functional or other information (e.g., AP running at 55% capacity, internal temperature 55 C, AP identifier) related to the AP. The example AP of FIG. 3 includes top cover 306 that includes top cover cutout 312 that allows display device to extend through, or be flush with, top cover 306. This allows display device 308 to be seen without being obscured by any portion of top cover 306.

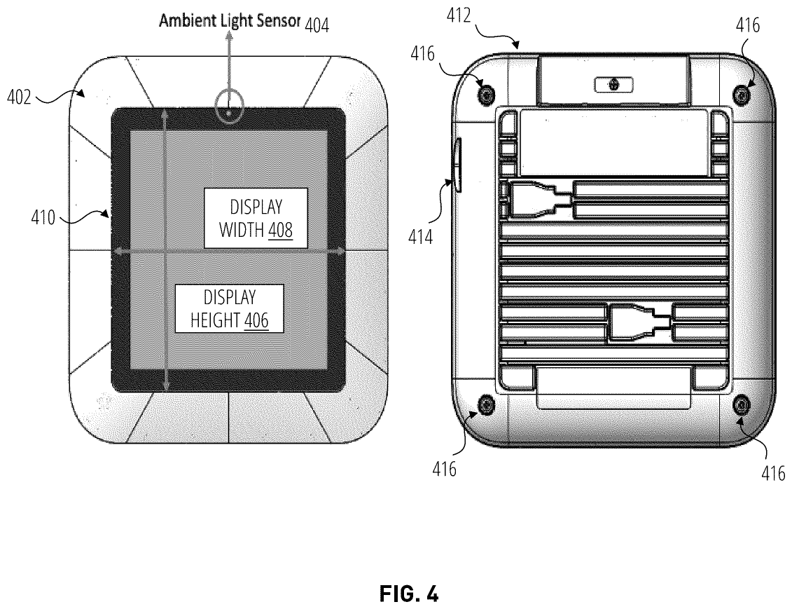

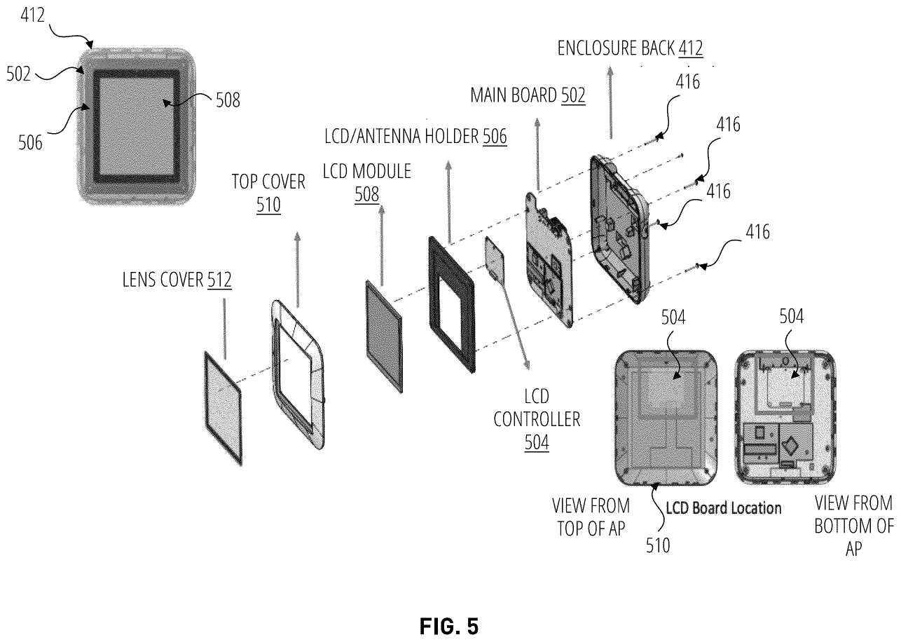

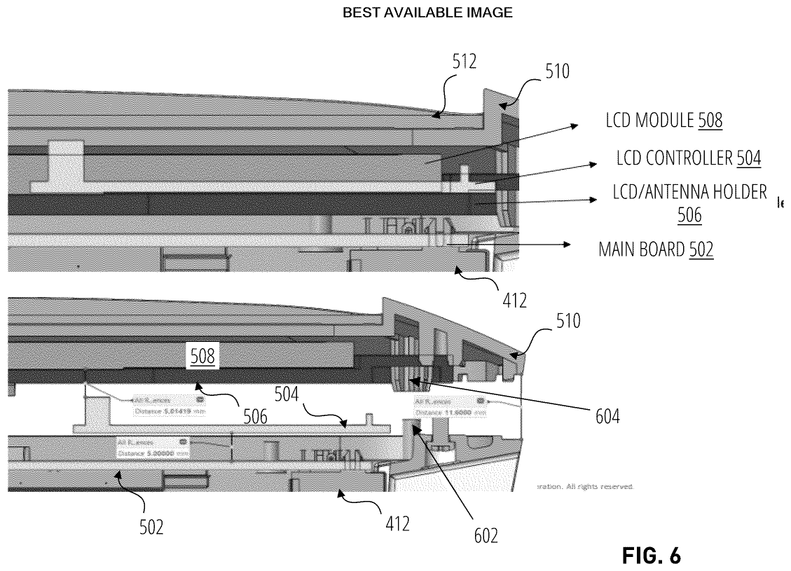

FIG. 4 illustrates an example AP enclosure top and back where the enclosure top allows for a display device. The illustration of FIG. 4 provides an example view of an assembled AP having a display device. Subsequent figures (i.e., FIG. 5, FIG. 6) provide additional views of a similarly configured AP having a display device.

In the example AP of FIG. 4, enclosure top 402 is configured to hold (or surround or cover with a lens) display device 410 to that at least a portion of what is displayed on display device 410 can be observed by human or non-human observers. In the example of FIG. 4, the portion of display device 410 that can be observed is illustrated in terms of display width 408 and display height 406. In an example, enclosure top 402 can include ambient light sensor 404, which is optional, but useful for determining ambient light levels, which can be considered when controlling the brightness of display device 410 and/or other features of the AP.

In an example, the AP further includes enclosure back 412. Enclosure back 412 and enclosure top 402 are configured to securely mate with each other to protect electronic components within the housing formed by enclosure top 402 and enclosure back 412. In an example, enclosure back 412 can include vent 414. In an example, enclosure top 402 and enclosure back 412 are secured via one or more screws 416. While enclosure top 402 is generally referred to as the top of the AP enclosure, in some examples, enclosure top 402 can be a bezel or frame that holds or frames a display lens (or cover) and/or display device 410.

FIG. 5 is an example illustration of an AP indicating relationships between various components of the AP. The example of FIG. 5 provides additional information for the configuration of FIG. 4 in terms of relationships between components within the overall AP enclosure (e.g., lens cover 512, top cover 510 and enclosure back 412).

The arrangement of various components in the AP can be important with respect to performance because antenna configurations and/or placements affect data transfer speeds, AP coverage and other factors. Similarly, placement of various components (e.g., LCD controller 504) can cause interference with other components if not placed properly. Also the placement and dimensions of the display device directly impact the usefulness of the information presented via the display device. Thus, the configuration of the various components of the AP must be considered and evaluated with the AP also include a display device.

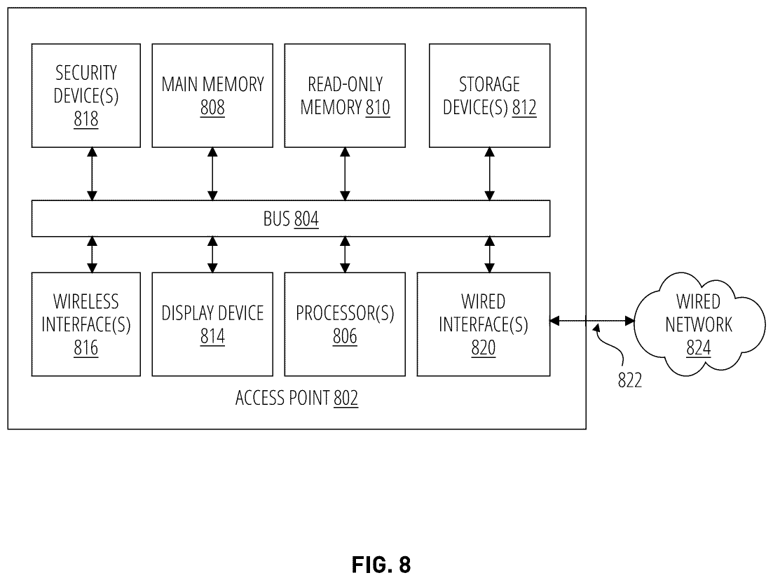

In the example of FIG. 5, main board 502 is disposed completely or partially within enclosure back 412 when the AP is assembled. In an example, main board 502 is a printed circuit board and attached components (e.g., processor chips, memory chips, resistors, capacitors, lines, sockets) that provides the functionality of the AP with the exception of some or all of the functionality relevant to LCD module 508. FIG. 8 is a block diagram of an AP that provides examples of the types of components that can be included on main board 502.

In an example, LCD controller 504 on top of main board 502; however, other configurations can also be supported. In an example, LCD controller 504 is a printed circuit board and attached components that control the operation of LCD module 508 in coordination with one or more components of main board 502.

In an example, LCD/antenna holder 506 is placed over LCD controller 504 and main board 502 to hold LCD controller 504 and main board 502 in place within enclosure back 412. In an example, LCD/antenna holder 506 is a non-conductive (e.g., plastic) component that has ridges, grooves, or other structures to hold one or more antennae to allow the AP to provide the desired wireless services. In an example, LCD/antenna holder 506 further includes ridges, grooves or other structures to maintain LCD module 508 in the desired position when the AP is fully assembled.

In an example, LCD module 508 includes a LCD display that is communicatively coupled with LCD controller 504 to provide the display functionality described herein. In various examples, the display device can be LCD-based; however, other technologies (e.g., light-emitting diode (LED)-based) can be utilized. In an example, LCD controller 504 may draw power from LCD controller 504 and/or main board 502 via various technologies (e.g., Elastometric, heatseal, Flexible Bus Connector (FBC)/Flexible Flat Cable (FFC), Universal Serial Bus (USB) port).

In an example, top cover 510 has an opening to frame some of all of the output of LCD module 508. In an example, top cover 510 mates with LCD/antenna holder 506 to secure 508 in a desired position within the assembled AP. In an example, 512 is disposed within the opening of 510 to protect 508 from external conditions while allowing a desired level of visibility of LCD module 508.

FIG. 6 is an example partial side-view illustration of an AP indicating relationships between various components of the AP with the AP fully assembled. The example of FIG. 6 provides additional information for the configuration of FIG. 4 and FIG. 5 in terms of relationships between components within the overall AP enclosure (e.g., lens cover 512, top cover 510 and enclosure back 412).

The upper portion of FIG. 6 illustrates the example AP in a fully assembled condition. The lower portion of FIG. 6 illustrates the example AP in a partially assembled condition to illustrate potential alignments and dimensional aspects of the configuration. In an example, one or more components of the AP can include alignment features (e.g., 602, 604).

Thus, with respect to a traditional AP design, the top cover is redesigned to accommodate the display device and an LCD controller module (or other type of controller). Further, one or more antennae parameters are modified to accommodate the inclusion of the display device and the LCD controller. One or more additional connectors have been added to the main board to provide control and/or management of the LCD via the LCD controller. Additional connectors and/or use of different transmit/receive parameters may also be utilized to compensate for the new antenna design.

In the examples above, a separate LCD controller is illustrated, however in alternate configurations, the LCD controller can be part of the main board. However, this would result in redesign of the main board and may provide a less flexible and/or more expensive main board. This may also necessitate new and/or different connectors on the main board or other components.

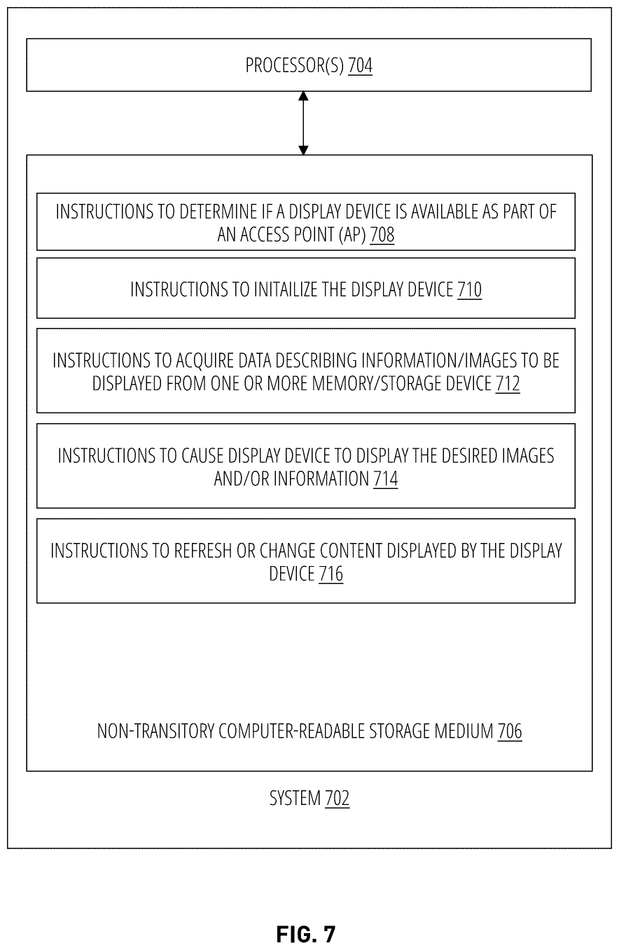

FIG. 7 is an example of a system to control and AP having a display device. In an example, system 702 can include processor(s) 704 and non-transitory computer-readable storage medium 706 (both of which can be on main board 502 and/or part of LCD controller 504). In some examples, non-volatile memory is also utilized by processor(s) 704. Non-transitory computer-readable storage medium 706 may store instructions 708, 710, 712, 714 and 716 that, when executed by processor(s) 704, cause processor(s) 704 to perform various functions. Examples of processor(s) 704 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 706 include tangible media such as random-access memory (RAM), read-only memory (ROM), electrically erasable programmable read-only memory (EEPROM), flash memory, a hard disk drive, etc.

Instructions 708 cause processor(s) 704 to determine if a display device is part of the access point (AP) and is available to (or accessible by) the processor. In various examples, processor(s) 704 can run an initiation sequence or evaluation procedure to determine the resources available. In an example, the determination of the availability of the display device can provide specific information related to the display device including, for example, display type, display size, resolution, refresh rate and/or other relevant parameters.

Instructions 710 cause processor(s) 704 to initialize the display device. In an example, processor(s) 704 can utilize the parameters and other information gathered when determining if the display device is available to properly initialize the display device.

Instructions 712 cause processor(s) 704 to acquire data describing information/images to be displayed from one or more memory/storage device. For example, if the display device is to display a static image, that image can be read from a memory device. As anther example, if the display device is to display dynamic information (e.g., a pie chart of network traffic), format information and/or dynamic data can be read from one or more sources to be organized and displayed.

Instructions 714 cause processor(s) 704 to cause display device to display the desired images and/or information. Processor(s) 704 may operate in conjunction with a display controller (e.g., LCD controller 504) that may include one or more processors, or processor(s) 704 may control the display controller to cause the desired images and/or information to be displayed on the display device.

Instructions 716 cause processor(s) 704 to refresh or change content displayed by the display device.

FIG. 8 is a block diagram that illustrates an example access point (AP). Notably, components of access point 802 described herein are meant only to exemplify various possibilities. In no way should example access point 802 limit the scope of the present disclosure. In the context of the present example, access point 802 includes bus 804 or other communication mechanism for communicating information and one or more processing resources (e.g., one or more hardware processor(s) 806) coupled with bus 804 for processing information. Hardware processor(s) 806 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In an example, access point 802 further includes security device(s) 818, which can be, for example, one or more processing resources may be part of an ASIC-based security processing unit (e.g., the FORTISP family of security processing units available from Fortinet, Inc. of Sunnyvale, CA).

Access point 802 also includes main memory 808, such as a random-access memory (RAM) or other dynamic storage device, coupled to bus 804 for storing information and instructions to be executed by processor(s) 806. Main memory 808 also may be used for storing temporary variables or other intermediate information during execution of instructions to be executed by processor(s) 806. Such instructions, when stored in non-transitory storage media accessible to processor(s) 806, render access point 802 into a special-purpose machine customized to perform the operations specified in the instructions.

Access point 802 includes a read-only memory 810 or other static storage device coupled to bus 804 for storing static information and instructions for processor(s) 806. Storage device(s) 812 (e.g., a magnetic disk, or flash disk (made of flash memory chips), is provided and coupled to bus 804 for storing information and instructions.

Access point 802 may be coupled via bus 804 to display device 814 (e.g., Liquid Crystal Display (LCD), Organic Light-Emitting Diode Display (OLED), Digital Light Processing Display (DLP) or the like, for displaying information as described herein. Access point 802 further includes wireless interface(s) 816, that can support, for example, Wi-Fi communications and associated relevant protocols.

Access point 802 may implement the techniques described herein using customized hard-wired logic, one or more ASICs or FPGAs, firmware or program logic which in combination with the computer system causes or programs access point 802 to be a special-purpose machine. According to one embodiment, the techniques herein are performed by access point 802 in response to processor(s) 806 executing one or more sequences of one or more instructions contained in main memory 808. Such instructions may be read into main memory 808 from another storage medium, such as storage device(s) 812. Execution of the sequences of instructions contained in main memory 808 causes processor(s) 806 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic, or flash disks, such as storage device(s) 812. Volatile media includes dynamic memory, such as main memory 808. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 804. Transmission media can also be acoustic or light waves, such as those generated during radio-wave and infrared data communications.

Various forms of media may be involved in carrying one or more sequences of one or more instructions to processor(s) 806 for execution. For example, the instructions may initially be carried on a magnetic disk or solid-state drive of a remote computer. Bus 804 carries the data to main memory 808, from which processor(s) 806 retrieve and execute the instructions. The instructions received by main memory 808 may optionally be stored on storage device(s) 812 either before or after execution by processor(s) 806.

Access point 802 also includes wired interface(s) 820 coupled to bus 804. Wired interface(s) 820 provides a two-way data communication coupling to network link 822 (e.g., Ethernet cable) that is connected to wired network 824. In an example is wired interface(s) 820, may be a local area network (LAN) card (or similar component) that provides a data communication connection to a compatible LAN. In any such implementation, wired interface(s) 820 sends and receives electrical, electromagnetic or optical signals that carry digital data streams representing various types of information.

Embodiments may be implemented as any or a combination of one or more microchips or integrated circuits interconnected using a parent board, hardwired logic, software stored by a memory device and executed by a microprocessor, firmware, an application-specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include but is not limited to, floppy diskettes, optical disks, CD-ROMs (Compact Disc-Read Only Memories), magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as the following claims.

Reference in the specification to “one example” or “an example” means that a particular feature, structure, or characteristic described in connection with the example is included in at least one embodiment of the disclosure. The appearances of the phrase “in one example” in various places in the specification do not necessarily refer to the same embodiment.

It is contemplated that any number and type of components may be added to and/or removed to facilitate various embodiments, including adding, removing, and/or enhancing certain features. For brevity, clarity, and ease of understanding, many standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component,” “module,” “system,” and the like as used herein are intended to refer to a computer-related entity, either software-executing general-purpose processor, hardware, firmware, or a combination thereof. For example, a component may be, but is not limited to, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer-readable media with various data structures stored thereon. The components may communicate via local and/or remote processes, such as in accordance with a signal having one or more data packets (e.g., data from one component interacting with another component in a local system, distributed system, and/or across a network such as the Internet with other systems via the signal).

Computer-executable components can be stored, for example, on non-transitory, computer-readable media including, but not limited to, an ASIC, CD, DVD, ROM, floppy disk, hard disk, EEPROM, memory stick or any other storage device type, in accordance with the claimed subject matter.

What is claimed is:

1. A wireless network access point (AP) comprising:
a rear enclosure section; and
a front enclosure section configured to mate with the rear enclosure section provide a housing to enclose electronic components that provide access point functionality to the AP, the front enclosure having at least a lens to provide visual access to a display device disposed within the housing, wherein the housing further encloses:
a main circuit board having one or more processors, one or more memory devices and a wired network interface,
a display device controller coupled with the main circuit board and with the display device, the display device controller to provide graphics processing functionality with respect to content displayed by the display device, and
a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae.

2. The access point of claim 1, wherein the display device comprises a liquid crystal display (LCD) device and the display device controller comprises and LCD controller.

3. The access point of claim 1, wherein the display device comprises a light emitting diode (LED) device and the display device controller comprises and LED controller.

4. The access point of claim 1, wherein the display device is caused to display a static image.

5. The access point of claim 1, wherein the display device is caused to display a dynamic image.

6. The access point of claim 5, wherein the dynamic content comprises statistical information related to operational parameters of the wireless network.

7. The access point of claim 5, wherein the dynamic content comprises customized information related to a device attempting to join the wireless network.

8. A wireless network comprising:
multiple access points (APs) interconnected to provide access to a wired network to a plurality of wireless devices, wherein a first AP of the multiple APs comprises:
a rear enclosure section; and
a front enclosure section configured to mate with the rear enclosure section provide a housing to enclose electronic components that provide access point functionality to the AP, the front enclosure having at least a lens to provide visual access to a display device disposed within the housing, wherein the housing further encloses:
a main circuit board having one or more processors, one or more memory devices and a wired network interface,
a display device controller coupled with the main circuit board and with the display device, the display device controller to provide graphics processing functionality with respect to content displayed by the display device, and
a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae.

9. The wireless network of claim 8, wherein the display device comprises a liquid crystal display (LCD) device and the display device controller comprises and LCD controller.

10. The wireless network of claim 8, wherein the display device comprises a light emitting diode (LED) device and the display device controller comprises and LED controller.

11. The wireless network of claim 8, wherein the display device is caused to display a static image.

12. The wireless network of claim 8, wherein the display device is caused to display dynamic content.

13. The wireless network of claim 12, wherein the dynamic content comprises statistical information related to operational parameters of the wireless network.

14. A wireless network access point (AP) comprising:
a rear enclosure section; and
a front enclosure section configured to mate with the rear enclosure section provide a housing to enclose electronic components that provide access point functionality to the AP, the front enclosure providing visual access to a display device disposed within the housing, wherein the housing further encloses:
a main circuit board having one or more processors, one or more memory devices and a wired network interface,
a display device controller coupled with the main circuit board and with the display device, the display device controller to provide graphics processing functionality with respect to content displayed by the display device, and
a display device and antenna holder configured to securely position the display device and one or more antennae within the housing when the rear enclosure section and the front enclosure section are securely attached together, wherein the positions of the display device and the one or more antennae are to minimize interference between the display device and the one or more antennae;
wherein the one or more processors of the main circuit board execute instructions stored by the one or more memory devices of the main circuit board, the instructions, when executed, cause the display device controller to cause the display device to display content as indicated by the instructions.

15. The access point of claim 14, wherein the display device comprises a liquid crystal display (LCD) device and the display device controller comprises and LCD controller.

16. The access point of claim 14, wherein the display device comprises a light emitting diode (LED) device and the display device controller comprises and LED controller.

17. The access point of claim 14, wherein the display device is caused to display a static image.

18. The access point of claim 14, wherein the display device is caused to display dynamic content.

19. The access point of claim 18, wherein the dynamic content comprises statistical information related to operational parameters of the wireless network.

20. The access point of claim 18, wherein the dynamic content comprises customized information related to a device attempting to join the wireless network.
